(19) United States
(12) Patent Application Publication
(10) Pub. No.: US 2002/0189443 A1
(43) Pub. Date: Dec. 19, 2002

(54) Method of removing carbon dioxide or hydrogen sulfide from a gas

(76) Inventor: Patrick L. McGuire, Eagle River, AK (US)

Correspondence Address: RICHMOND, HITCHCOCK,, FISH & DOLLAR, P.O. Box 2443, Bartlesville, OK, 74005, US

(21) Appl. No.: 09/884,202

(22) Filed: Jun. 19, 2001

(51) Int. Cl. B01D 45/00

(52) U.S. Cl. 95/32

(57) ABSTRACT

A method is provided for separating methane from carbon dioxide contained in a high pressure gas which comprises expanding the high pressure gas through a flow channel having a convergent section followed by a divergent section with an intervening throat which functions as an aerodynamic expander to obtain a gaseous stream enriched in methane and a heavy stream comprised enriched in carbon dioxide, hydrogen sulfide, ethane and heavier components. Generally, the flow channel is operated at temperatures low enough to result in the formation of solid carbon dioxide and solid hydrogen sulfide particles, which increases the efficiency of carbon dioxide and hydrogen sulfide removal.

### BACKGROUND OF THE INVENTION

The present invention relates to a method of separating methane from carbon dioxide, water, hydrogen sulfide, ethane and heavier hydrocarbon compounds from a high-pressure gas stream. In particular, the present invention relates to such a method in which the gas may contain a relatively large amount of carbon dioxide.

The problems associated with prior art systems for separating methane from carbon dioxide, water, hydrogen sulfide, ethane, and heavier hydrocarbon compounds from a high-pressure gas stream are best illustrated by the separation of high and low boiling hydrocarbons of natural gas. Natural gas, as it is received from a subsurface formation, generally is not suitable for direct use without some processing, since it contains carbon dioxide, hydrogen sulfide and water as contaminants. The processing operations carried out in a natural gas plant are to first pass the gas through a dehydration system to remove water and then to remove carbon dioxide and hydrogen sulfide. The amount of water, carbon dioxide and hydrogen sulfide contained in the gas vary considerably but most natural gases contain significant amounts of these contaminants. In cryogenic separation techniques, the water is removed prior to cryogenic separation and the carbon dioxide and hydrogen sulfide are typically removed by a chemical absorption process. The preliminary dehydration adds to the cost of the operation. After removal of water, carbon dioxide and hydrogen sulfide, the resulting gas can then be used as a fuel. However, such gases generally contain varying but significant amounts of higher molecular weight hydrocarbon compounds, such as ethane and, to a lesser extent, propane, butanes and other higher molecular weight hydrocarbons. The ethane and other high molecular weight hydrocarbons contribute relatively little heating value to the natural gas and accordingly, these materials have a significantly greater value as chemical feedstocks or as injectants in improved oil recovery operations than these materials have as fuel.

The natural gas feed to a natural gas plant will generally be near atmospheric temperature and at an elevated pressure substantially above atmospheric pressure, either as it is produced from the gas formation or as a result of compression of the produced gas. Therefore, it has long been known to separate ethane and higher molecular weight hydrocarbons from ethane by a combination of plural cooling stages and at least one expansion stage and separating the cooled and expanded fluid by fractional distillation in a “demethanizer” to produce a vapor stream substantially higher in methane content than the original gas and a liquid stream substantially higher in ethane and higher hydrocarbons content than the original gas.

The need to remove the water, carbon dioxide and hydrogen sulfide impurities prior to substantial cooling and fractional distillation is driven because such components will freeze out under the fractional distillation conditions and potentially plug up a distillation column as well as other equipment thereby making the process inoperative. Patents such as U.S. Pat. Nos. 4,115,086; 4,274,850; and 4,451,274 have warned that such freezing out is to be avoided during processes for recovering ethane and higher molecular weight hydrocarbons from natural gas. Most prior art processes of recovering natural gas have used expensive dehydration and absorption processes to remove the water, carbon dioxide and hydrogen sulfide components prior to removing the ethane and higher molecular weight hydrocarbons from the methane.

Accordingly, it would be advantageous to have an efficient, relatively low cost system for removing water, carbon dioxide, and hydrogen sulfide from a high pressure gas stream which avoids utilizing expensive dehydration and absorption processes.

### SUMMARY OF THE INVENTION

It is therefore an object of the present invention to provide an improved method of removing water, carbon dioxide, hydrogen sulfide, ethane and heavier components from a high pressure gas stream comprising methane, water, carbon dioxide, hydrogen sulfide, ethane and other heavier hydrocarbon compounds.

It is also an object of the present invention to provide a method of said separation that does not require a fractionation tower.

It is a further object of the invention to provide a method of removing water, carbon dioxide, hydrogen sulfide, ethane and heavier components from a high pressure gas stream comprising methane, water, carbon dioxide, hydrogen sulfide, ethane and heavier hydrocarbon compounds from a high pressure gas stream comprising methane, water, carbon dioxide, hydrogen sulfide, ethane and other heavier hydrocarbon components which takes advantage of the propensity of carbon dioxide, hydrogen sulfide and water to freeze out at low temperatures.

In accordance with an embodiment of the present invention, a method is provided for separating methane from carbon dioxide contained in a high pressure gas stream wherein the high pressure gas stream is at a first pressure. The method is especially useful when the high pressure gas stream contains methane, carbon dioxide, hydrogen sulfide, water and heavier compounds. The term “heavier hydrocarbon compounds” as used herein refers to organic compounds such as ethane and higher molecular weight hydrocarbon compounds. The method includes the steps of (a) cooling the high pressure gas stream by indirect heat exchange; and/or (b) cooling the high pressure gas stream by expanding the high pressure gas from said first pressure to a second pressure wherein said second pressure is lower than the first pressure to produce a chilled gas stream; and (c) introducing the chilled gas stream into a flow channel having a convergent section followed by a divergent section with an intervening throat which functions as an aerodynamic expander such that a major portion of carbon dioxide is condensed within the flow channel to produce a first portion from the chilled gas stream comprising primarily methane gas and a second portion from said lower pressure gas stream comprising primarily the condensed carbon dioxide; and (d) removing the first portion as a product.

### BRIEF DESCRIPTION OF THE FIGURES

FIG. 1 shows a flow scheme of a process in accordance with the invention for removing carbon dioxide, hydrogen sulfide, water and heavier hydrocarbon compounds from a high pressure gas stream comprising methane, carbon dioxide, hydrogen sulfide, water and heavier hydrocarbon compounds.

FIG. 2 illustrates flash calculations for removal of carbon dioxide.

### DETAILED DESCRIPTION OF THE PREFERRED EMBODIMENTS

In accordance with the present invention, methane is separated from the other components of a high-pressure gas stream, especially carbon dioxide. The methane is separated from the carbon dioxide by condensing the carbon dioxide to a solid in a flow channel having a convergent section followed by a divergent section with an intervening throat.

The preferred high pressure gas stream employed in the present invention is a natural gas stream and can be any natural gas stream containing an undesirably high level of carbon dioxide. The natural gas stream typically comprises hydrocarbons such as methane, ethane, propane, butane, and pentanes (as used herein “heavier hydrocarbon compounds” refers to ethane and heavier molecular weight hydrocarbons), as well as other compounds such as carbon dioxide, helium, hydrogen sulfide, nitrogen, water, and oxygen. Preferably, the natural gas stream comprises more than 50 volume percent methane by volume of the total natural gas stream but will also have an appreciable volume of carbon dioxide, typically from 1 volume percent to 40 volume percent. More preferably, the natural gas stream contains from 5 volume percent to 20 volume percent carbon dioxide. The natural gas stream preferably contains less than 30 volume percent of hydrocarbons other than methane. More preferably, the natural gas stream contains from 1 volume percent to 20 volume percent hydrocarbons other than methane.

The inventive method is particularly useful when treating high-pressure natural gas streams, typically at a pressure greater than about 500 psig. Preferably, the pressure of the natural gas stream is from 1000 psig to 5000 psig, most preferably from 1000 psig to 2500 psig. The temperature of the natural gas stream which is treated by the present inventive system is preferably from −40° F. to about 200° F., more preferably, the temperature of the natural gas stream is from 20° F. to 120° F.

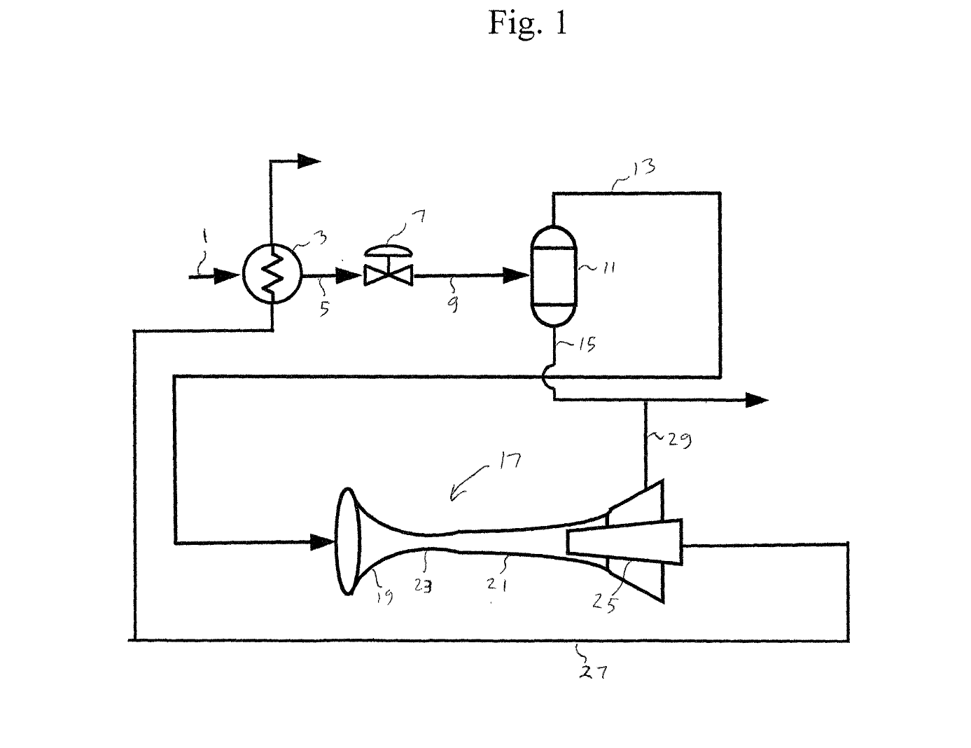

Referring now to FIG. 1, a process in accordance with the invention is illustrated. A high-pressure gas stream comprising methane and one or more components selected from carbon dioxide, water, hydrogen sulfide, ethane and heavier hydrocarbon compounds is introduced into the process via conduit 1. Conduit 1 is in fluid flow communication with heat exchanger 3 and, accordingly, the high-pressure gas stream is fed into heat exchanger 3 and is cooled by indirect heat exchange with methane stream 27. The now cooled gas inlet stream is then fed via conduit 5 into an expansion device 7 wherein the stream is further cooled by expansion. Expansion device 7 will typically be a Joule-Thompson valve, but can be another suitable device such as a turbo-expander. The resulting chilled inlet stream, which may contain both gas and liquid, may be fed via conduit 9 into separation vessel II or may be fed directly to flow channel 17. Within separation vessel 11 heavier hydrocarbon compounds are separated out of the chilled inlet stream. This separation is carried out at temperatures and pressures sufficient to insure that no freeze out of the carbon dioxide, water or hydrogen sulfide occurs. If desired this preliminary separation in separation vessel 11 can be omitted.

The gas outlet stream from the separation vessel 11 is delivered into flow channel 17 via conduit 13. The gas outlet stream entering flow channel 17 will have a lower temperature than the high pressure feed gas but will have a temperature greater than the freezing point of carbon dioxide at the associated pressure. Flow channel 17 has a convergent section 19 followed by a divergent section 21 with an intervening throat 23 which functions as an aerodynamic expander such that most of the carbon dioxide and any heavier hydrocarbon compounds are condensed into a liquid or solid state within said flow channel. A device to impart a swirl to the flow is included within divergent section 21. Typically, this device will be a wing. Accordingly, a first portion of the gas outlet stream comprising mostly methane is separated from a second portion of the gas outlet stream containing most of the condensed carbon dioxide, water, hydrogen sulfide and heavier hydrocarbon compounds. The first portion of the gas outlet stream will have a tendency to travel along the axis of the flow channel and second portion of the gas outlet stream will have a tendency to travel along the outside wall of the flow channel. Accordingly, the first portion and second portion can be separated by partition 25. The first portion is removed via conduit 27, used to cool the incoming high-pressure gas stream introduced through conduit 1 into heat exchanger 3 and can then be removed as a product gas.

The second portion is removed via conduit 29 and is combined with the heavy outlet stream 15 coming from separation vessel 11. This combined stream, which is enriched in carbon dioxide and heavier hydrocarbon compounds can be utilized for various purposes such as a chemical feedstock or as an injectant in improved oil recovery operations.

The above-described process utilizes a flow channel having a convergent section followed by a divergent section with an intervening throat which functions as an aerodynamic expander to separate methane from carbon dioxide, hydrogen sulfide, water and heavier compounds. One type of flow channel suitable for use in the present invention is a supersonic separator. U.S. Pat. Nos. 3,528,216,3,528,217, 3,528,221, 3,559,373 of Garrett and U.S. Pat. Nos. 4,292,050 of Linhard, et al., and U.S. Pat. No. 5,306,330 from Nasikas, all refer to a supersonic separator. Garrett's patents are based upon the centrifugal separation of droplets and to their discharge via a permeable wall. The droplets in Linhard's patent are separated by means of a change in the direction of flow of the gas stream at the region of the oblique shock wave in relation to the flow of the droplets and by means of a subsequent centrifugal separation by means of a curved portion under supersonic conditions. The droplets of Nasikas' patent are separated by means of a normal shock wave, downstream of which the droplets because of their inertia have a speed relatively higher than the remaining flow. Upstream of either the oblique or the normal shock wave, the gas and droplets flow at approximately the same speed. Immediately downstream of the shock wave, the speed of the gas flow is abruptly reduced, whereas the droplets maintain the speed they had upstream of the shock wave. This speed difference is the main cause of centrifugation of droplets in the downstream portion of the nozzle. In all these patents, the droplets are inertially separated from the gas stream and two flow zones emerge, one zone free from droplets and one enriched with droplets, these two zones being subsequently separated.

Supersonic separation devices based upon the above patents commonly use a Laval nozzle and a means of separating the gas and heavy product streams which result from the large pressure reduction and large temperature drop in the throat section of the Laval nozzle. A key feature of these units is their ability to remove water from the gas at operating temperatures in the throat of the Laval nozzle in the range of −50° F. without plugging with ice or hydrates. In the current invention, as the liquid droplets and/or solid particles slow down from supersonic velocities to subsonic velocities, a great deal of kinetic energy is converted back into heat. It is this fact, along with the very short residence time in the throat, that allows these devices to operate successfully in the current invention at temperatures that would cause plugging downstream of Joule-Thompson valves or turbo-expanders. Immediately after passing through the throat section the chilled gas stream will have a pressure of less than 400 psig and a temperature of less than −110° F. (preferably less than −130° F.). Under these conditions a substantial portion of the carbon dioxide, water, and hydrogen sulfide will condense out of the gas phase with the carbon dioxide, water and hydrogen sulfide generally being in a solid phase. As the gaseous and condensed components of the chilled stream travel down the divergent section of the flow channel, the gaseous components will tend to travel along the axis and the condensed components along the outer wall of the divergent section. Following the outlet shock front which occurs near the point of separation at partition 25, the pressure and temperature will increase with the condensed components tending to return to gaseous form. Accordingly, after separation at partition 25 the first portion and second portion of the chilled gas streams will be at a pressure greater than 400 psig (preferably greater than 500 psig) and at a temperature greater than 110° F. Under these conditions any solidified carbon dioxide and any solidified water or hydrogen sulfide will change to gas or liquid phase.

While the inventive process has been described above in terms of a high pressure gas stream (i.e., greater than about 500 psig), the invention may be utilized successfully as long as the ratio of the pressure of the inlet gas stream (the natural gas stream introduced to the aerodynamic expander) to the pressure of the outlet gas stream (the gas stream after separation at partition 25) falls within a suitable range. Accordingly, the outlet gas stream will have a pressure from 50% to 80% of the inlet gas stream pressure. Additionally, immediately after passing through the throat section, the chilled gas stream will have a pressure from 15% to 45% of the inlet stream pressure. Preferably, the outlet gas stream pressure will be from 60% to 75% of the inlet gas stream pressure and the pressure immediately after passing through the throat section will be from 20% to 40% of the inlet gas stream pressure. Generally, good results can also be achieved when the above ratios are utilized with a low pressure gas stream.

### CALCULATED EXAMPLE

The advantages of the present invention can be illustrated with flash calculations using an exemplary high pressure gas. The high pressure gas of this example has a carbon dioxide concentration of about 12 volume percent.

If the gas is cooled to a temperature below −110° F., laboratory tests show that carbon dioxide will precipitate in solid form and a three-phase vapor-liquid-solid equilibrium condition will be achieved. If the supersonic separation device is operated such that throat temperatures are below −110° F., this fact should allow for removal of most of the carbon dioxide as fine solid particles entrained in the hydrocarbon liquid. As stated in several of the afore-referenced patents, a gas plant designed with the prior art cannot be prudently operated at these conditions.

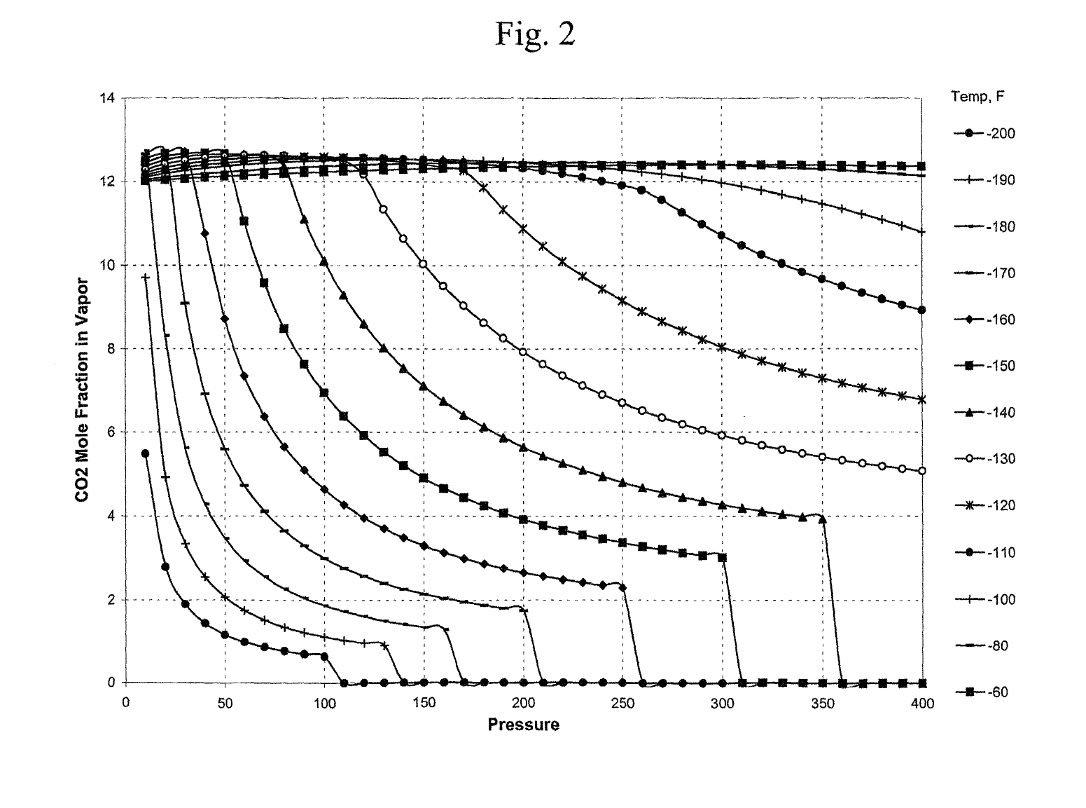

Referring to FIG. 2, the flash calculations of the outlet gas from such a plant is illustrated. Vapor phase carbon dioxide concentrations from prior art systems which operate at temperatures above −110° F. would be essentially unchanged from that of the inlet gas. Any significant reductions in vapor phase carbon dioxide concentration at these temperatures would require the use of a fractionation tower. Conversely, with the present invention, carbon dioxide concentrations in the vapor phase drop rapidly as the gas processing temperature is reduced below −110° F. without any requirement for a fractionation tower.

From the data shown in FIG. 2, it can be concluded that with the method of the present invention one can remove carbon dioxide and heavier hydrocarbon compounds from a high-pressure gas stream comprising methane, carbon dioxide, ethane and heavier hydrocarbon compounds. The method of the present invention is tolerant to high concentrations of carbon dioxide in the gas that are beyond the range of the prior art.

While this invention has been described in terms of the presently preferred embodiments, reasonable variations and modifications are possible to those skilled in the art and such variations are within the scope of the described invention and the appended claims.

That which is claimed is:

1. A method of separating methane from carbon dioxide contained in a high pressure gas stream wherein said high pressure gas stream is at a first pressure, wherein the method comprises the steps of:
(a) cooling said high pressure gas stream to produce a chilled gas stream;
(b) introducing said chilled gas stream into a flow channel having a convergent section followed by a divergent section with an intervening throat which functions as an aerodynamic expander such that a major portion of the carbon dioxide is condensed into a liquid or solid state within said flow channel to produce a first portion from said lower pressure gas stream comprising primarily methane gas and a second portion from said lower pressure gas stream comprising primarily said condensed carbon dioxide; and
(c) removing said first portion as a product.

2. A method according to claim 1 wherein said high pressure gas additionally contains hydrogen sulfide and higher hydrocarbon compounds and wherein in step (b) said second portion comprises condensed carbon dioxide, condensed hydrogen sulfide and condensed heavier hydrocarbon compounds.

3. A method according to claim 2 further comprising prior to step (b) introducing said chilled gas stream into a separation vessel to separate at least some of said heavier hydrocarbon compounds out of said chilled gas stream.

4. The method of claim 3 wherein said flow channel is operated at pressures low enough to eliminate the need for a fractionation column to reduce the methane content of said second portion gas stream.

5. The method of claim 4 wherein said cooling of said high pressure gas stream is carried out by indirect heat exchange.

6. The method of claim 4 wherein said cooling of said high pressure gas stream is carried out by expanding said high pressure gas stream from said first pressure to a second pressure wherein said second pressure is lower than said first pressure.

7. A method of claim 4 wherein said cooling of said high pressure gas stream is carried out by indirect heat exchange and by thereafter expanding said high pressure gas stream from said first pressure to a second pressure wherein said second pressure is lower than said first pressure.

8. A method according to claim 1 wherein immediately after said throat section of said flow channel the components of said chilled gas stream introduced into said flow channel have a temperature below −110° F.

9. A method according to claim 8 wherein said first portion and second portion have outlet pressures from 50% to 80% of the pressure of said chilled gas stream.

10. A method according to claim 9 wherein within said chilled gas stream has a pressure greater than about 800 psig prior to introduction into said flow channel and a pressure of less than 400 psig immediately after said throat section of said flow channel and said first portion and second portion have pressures of greater than 400 psig after separation within said flow channel.

11. A method according to claim 10 wherein immediately after said throat section of said flow channel the components of said chilled gas stream introduced into said flow channel have a temperature below −30° F.

12. A method according to claim 8 wherein said first portion and second portion have outlet pressures from 60% to 75% of the pressure of said chilled gas stream.

13. A method according to claim 12 wherein within said chilled gas stream has a pressure greater than about 1000 psig prior to introduction into said flow channel and a pressure of less than 400 psig within said throat section of said flow channel and said first portion and second portion have pressures of greater than 600 psig after separation within said flow channel.

14. A method according to claim 13 wherein said high pressure gas additionally contains hydrogen sulfide and heavier hydrocarbon compounds and wherein in step (c) said second portion comprises condensed carbon dioxide, condensed hydrogen sulfide and condensed higher hydrocarbon compounds.

15. A method according to claim 14 further comprising prior to step (c) introducing said chilled gas stream into a separation vessel to separate at least some of said heavier hydrocarbon compounds out of said chilled gas stream.
